(19) United States
(12) Patent Application Publication
(10) Pub. No.: US 2026/0175200 A1
(43) Pub. Date: Jun. 25, 2026

(54) CATALYST

(71) Applicant: Universitetet i Oslo, Oslo (NO)

(72) Inventors: Athanasios CHATZITAKIS, Oslo (NO); Xiaolan KANG, Bozhou City, Anhui (CN); Kevin BOTH, Oslo (NO)

(21) Appl. No.: 19/126,750

(22) PCT Filed: Nov. 8, 2022
(86) PCT No.: PCT/EP2022/081163

§ 371 Date: May 2, 2025

(30) Foreign Application Priority Data
Nov. 4, 2022 (GR) 20220100903

(51) Int. Cl. B01J 23/00; B01J 23/42

(52) U.S. Cl. CPC B01J 23/002; B01J 23/42

(57) ABSTRACT

The invention provides a solid catalyst comprising a bulk material containing metal nanoparticles, wherein a portion of said nanoparticles partially protrude from the surface of the bulk material and said nanoparticles are characterised in that they comprise noble metals or non-noble metals on their surface.

This invention concerns solid catalysts. In particular, it relates to a solid catalyst comprising a bulk material containing metal nanoparticles, wherein a portion of said nanoparticles partially protrude from the surface of the bulk material. Furthermore, said nanoparticles are characterised in that they comprise noble metals or non-noble metals on their surface. The invention also relates to a process for producing said catalysts.

### BACKGROUND

Metallic nanoparticles (NPs) are crucial in a broad range of applications, such as catalysis, photo-catalysis, plasmonics, electronics, sensors, and photovoltaics. Generally, their properties and targeted functionalities can be tuned by adjusting parameters such as structure, morphology, and composition. More specifically, bimetallic NPs exhibit unique properties outperforming their monometallic counterparts, as is the case for Ir—Ru bimetallic composites, which are efficient and stable electrocatalysts for the oxygen evolution reaction (OER) in acidic solutions. Another example is Pd—Ag bimetallic structures, which can increase the selectivity in the hydrogenation of ethylene compared to the widely used Pd or Ag monomers, a fact attributed to modulation of hydrogen adsorption on Pd in the composites. Bimetallic composites involving plasmonic metals, like Au, Ag, Cu, and Al are of particular interest because of the localized surface plasmon resonance (LSPR) effect, which renders them important photosensitizers in semiconductor-supported systems for photocatalytic and photoelectrochemical (PEC) applications. Recently, the antenna-reactor effect has been demonstrated, in which plasmonic NPs (antenna) induce a localized field that can significantly enhance the catalytic reaction rates on adjacent NPs (reactor). This system has the advantage of combining the optical response of plasmonically active metals and the catalytic abilities of catalytically active metals.

Applications of such catalysts include industrial catalysis, such as water electrolysis (e.g. NEL) systems, fertilizers (e.g. Yara) and industries with CO₂ emissions, optical and electrochemical sensors, and regeneration of NADH, which is a very expensive molecule (10.000 to 100.000 USD/mol) and its regeneration process is still a big industrial challenge. We mark it as an energy problem, because the current industrial methods are extremely energy intensive (inability to reuse the catalysts, expensive downstream separations).

The synthesis of such supported multi-metallic NPs with targeted structural features is hence of great importance, but very challenging. The current deposition methods (precipitation and co-precipitation, sputtering, deposition and physical adhesion, electrodeposition, ALD, CVD etc) are unable to produce well adhered catalytically active nanoparticles because the deposition is happening from an external source and to the substrate. There thus remains a need to provide new catalyst materials and to investigate novel synthetic methods for such materials.

### SUMMARY OF INVENTION

The present inventors have surprisingly found that new catalyst materials with tunable catalytic activity can be prepared by a method which involves the combination of metal exsolution with a galvanic replacement (GRR) and/or deposition reaction.

In exsolution, nanoparticles come from the bulk of the material and precipitate, or exsolve from the bulk to the surface. Therefore, the nanoparticles are actually directly embedded/socketed on the material's surface. This method is called in situ metal exsolution and is well known. The present inventors have further manipulated these exsolved and well-adhered nanoparticles by the method of galvanic replacement reaction (GRR) and or galvanic deposition reaction. In GRR, the metals in the exsolved nanoparticles are actually sacrificial and can be replaced by other particles, such as Pt, Ir, Au, Ru and many others. By fine tuning the GRR conditions, the inventors found that they could replace single atoms from the sacrificial nanoparticle with atoms of the wanted element. In the galvanic deposition reaction, the new atoms deposit on the surface of the metals in the nanoparticles.

The present invention thus offers a route to easily supported multi-metallic catalysts, which can have tunable catalytic activity and low amounts of critical elements, therefore higher potential for scaled up production. The invention may also permit the preparation of single atom containing catalysts. Moreover, the dispersed elements on the original nanoparticle unexpectedly have a synergistic effect, boosting the catalytic activity of the material.

Thus, viewed from a first aspect the invention provides a solid catalyst comprising a bulk material containing metal nanoparticles, wherein a portion of said nanoparticles partially protrude from the surface of the bulk material and said nanoparticles are characterised in that they comprise noble metals or non-noble metals on their surface.

Viewed from another aspect, the invention provides a process for preparing a solid catalyst as hereinbefore defined, said process comprising the steps:
(i) providing a bulk material comprising at least one metal dopant;
(ii) subjecting said bulk material to reducing conditions so as to allow exsolution of nanoparticles of the metal dopant;
(iii) contacting the bulk material obtained in step (ii) with a solution comprising noble metal ions or non-noble metal ions so as to allow galvanic replacement and/or deposition of said noble metal ions or non-noble metal ions on said nanoparticles as metallic heteroatoms.

### Definitions

The term “nanoparticle” as used herein means a material with overall dimensions in the nanoscale, e.g. in the range 1 nm to 100 nm.

### DETAILED DESCRIPTION OF INVENTION

The present invention relates to a solid catalyst comprising a bulk material containing metal nanoparticles, wherein a portion of said nanoparticles partially protrude from the surface of the bulk material. Furthermore, said nanoparticles are characterised in that they comprise noble metals or non-noble metals on their surface. The invention also relates to a process for preparing the catalysts.

### Bulk Material

The solid catalyst of the invention comprises a bulk material, which itself comprises metal nanoparticles. The bulk material may be any material suitable for acting as a support for metal nanoparticle, however typically it is a metal oxide. Examples oxides include binary oxides, such as aluminium oxide (Al₂O₃), silicon dioxide (SiO₂), cerium dioxide (CeO₂) or titanium dioxide (TiO₂).

Particularly preferred oxides are perovskites, such as those represented by the general formula ABO₃, wherein A is an alkali metal, alkaline earth metal, transition metal or mixture thereof and B is a transition metal, group IIIA metal, group IVA metal, or a mixture thereof. The metal or metals A are typically monovalent or divalent metals. The metal or metals B are typically tetravalent or pentavalent metals. For perovskites of general formula ABO₃, they may be stoichiometric perovskites, A-site deficient perovskites or A-site excess perovskites.

In a preferred embodiment, A is selected from the group consisting of Li, K, Ca, Sr and B is selected from the group consisting of Ti, Nb, Zr and Sn.

Particularly preferred bulk materials include BaTiO₃, SrTiO₃, LiNbO₃ and BaZrO₃. Most preferred is SrTiO₃.

In one embodiment, the perovskite may be doped with further metals, such as La and/or Ni.

Another class of perovskites which may be used are double perovskites, such as those represented by the general formula AA′BB′O₆, wherein A and A′ are independently an alkali metal, alkaline earth metal, transition metal or mixture thereof and B and B′ are independently a transition metal, group IIIA metal, group IVA metal, or a mixture thereof. The metal or metals A are typically monovalent or divalent metals. The metal or metals B and B′ are typically tetravalent or pentavalent metals. An example of a double perovskite of this formula is BaGdLaCoO₆.

### Metal Nanoparticles

The metal nanoparticles may be nanoparticles comprising any metal, but are preferably nanoparticles comprising a transition metal. Particularly preferred transition metals are nickel (Ni), iron (Fe), cobalt (Co), Copper (Cu), Chromium (Cr), Selenium (Se), Manganese (Mn), Tellurium (Te), Gallium (Ga). Most preferred are nickel (Ni), iron (Fe), cobalt (Co) and Copper (Cu).

The metal nanoparticles further comprise noble metals or non-noble metals on their surface. Preferable noble metals are ruthenium (Ru), rhodium (Rh), palladium (Pd), osmium (Os), iridium (Ir), platinum (Pt), gold (Au) and silver (Ag).

Preferable non-noble metals include, copper (Cu) and molybdenum (Mo), Tellurium (Te) and Tin (Sn).

It is preferred if the non-noble metals are non-noble transition metals, such as copper (Cu) and molybdenum (Mo).

The noble metals or non-noble metals may be present in the form of single atoms.

In one particularly preferred embodiment of the invention, the noble metals or non-noble metals are present on the surface of the nanoparticles only, i.e. they are not present on the surface of the bulk material.

A first preferred aspect of the invention relates to a catalyst in which the nanoparticles comprise Ni and the noble metal is Au or Pt. Another preferred aspect of the invention relates to a catalyst in which the nanoparticles comprise Cu and the noble metal is Ag. An alternative preferred aspect of the invention relates to a catalyst in which the nanoparticles comprise Fe and the non-noble metal is Mo.

One attractive feature of the catalysts of the invention is that they may permit attainment of catalytic activity in line with the performance of commercially available catalysts at significantly lower contents of the noble metal or non-noble metal. For example, the content of the noble metal or non-noble metal may be in the range 0.05 to 0.5 wt %, relative to the total weight of the catalyst.

### Catalyst

The catalyst may in the form of a powder or a film. Where the catalyst is in the form of a film, this is typically prepared via pulsed laser deposition. This method, which is well known in the art, generally involves hitting the target (such as a pelletised powder) with a high power laser, vaporizing it and transferring it to a substrate. Typical substrates include silicon, glass, fused Silica/Quartz, Glassy carbon, graphite, Ti (Titanium) foil, Nb (Niobium) foil, Au (gold), transparent conducting oxides such as Indium doped Tin Oxide (ITO) and Fluorine doped Tin Oxide (FTO).

### Process

The invention further relates to processes for preparing the catalysts as hereinbefore defined. Thus, all preferable aspects defined above apply equally to the process embodiments.

The process of the invention comprises the following steps:
(i) providing a bulk material comprising at least one metal dopant;
(ii) subjecting said bulk material to reducing conditions so as to allow exsolution of nanoparticles of the metal dopant;
(iii) contacting the bulk material obtained in step (ii) with a solution comprising noble metal ions or non-noble metal ions so as to allow galvanic replacement and/or deposition of said noble metal ions or non-noble metals ions on said nanoparticles as metallic heteroatoms.

It will be understood that the metal dopant referred to herein relates to the same metal which forms the metal nanoparticles in the solid catalyst as hereinbefore defined. Thus, the same definitions apply.

Step (ii) of the process is an exsolution step. Exsolution is a well-known technique in the art and thus the skilled person will be familiar with suitable reducing conditions which will result in exsolution of nanoparticles of the metal dopant. For example, the exsolution may take place under H₂, CO, CH₄, CO₂ or NH₃ atmospheres. Besides, plasma-driven, or applying electrical polarization at elevated temperatures have also been used to induce B-site exsolution. In some embodiments, CaH₂ is employed in the exsolution step (ii). The temperature of the exsolution step (ii) will vary depending on the nature of the bulk material and the nanoparticles, however typically it will be in the range 500 to 1100° C., such as 800 to 900° C. In embodiments wherein CaH₂ is employed in the exsolution step, the temperature of this step is preferably 600° C. Generally, the exsolution step takes place at atmospheric pressure. Exsolution of nanoparticles is quite a fast process, usually in the first few minutes or even seconds, nanoparticles can exsolve from the oxides at the target temperature and atmosphere. Since the kinetics of exsolution varies with different materials, a few minutes to several hours have been employed for desired exsolution.

Step (iii) involves a galvanic replacement reaction or galvanic deposition reaction. The person skilled in the art will be familiar with these terms and will understand that where galvanic replacement takes place, the noble metal ions or non-noble metals ions will at least partially replace the exposed metal atoms of the nanoparticle. Conversely, where galvanic deposition takes place the noble metal ions or non-noble metal ions will deposit on top of the exposed metal ions of the nanoparticle. It will be understood that the processes of the invention are intended to cover both these possibilities.

The solution in step (iii) is typically an aqueous solution (i.e. one comprising water as the main solvent, or consisting of water as the sole solvent). Preferably, the aqueous solution is an acidic aqueous solution, i.e. one with a pH of less than 7.0.

The solution employed in step (iii) typically comprises the noble metal ions or non-noble metal ions at a concentration of 1×10⁻⁷ molL⁻¹ to 1×10⁻³ molL⁻¹. In some embodiments, the aqueous solution may further comprise soluble polymers or surfactants (such as PVP or Triton X, CTAX and others). Step (iii) may be carried out under any conditions suitable for enabling the galvanic replacement reaction to take place. In one embodiment, step (iii) takes place at a temperature of 1 to 90° C., and typically lasts from few seconds to less than an hour.

In one embodiment of the invention, the process comprises a further step (iv) thermal annealing of the catalyst formed in step (iii). This thermal annealing step may take place in oxidising (e.g. in air) or reducing (e.g. in H₂, N₂, Ar, CO, CO₂ or NH₃ atmospheres) conditions.

### Application

The catalyst of the present invention may find application in a wide range of end applications, such as photo-catalysis, plasmonics, electrocatalysis (including water electrolysis, CO₂ reduction and N₂ fixation to ammonia or other oxygenates), electrosynthesis (NADH regeneration) electronics, sensors and photovoltaics.

The invention will now be described with reference to the following non-limiting examples and figures.

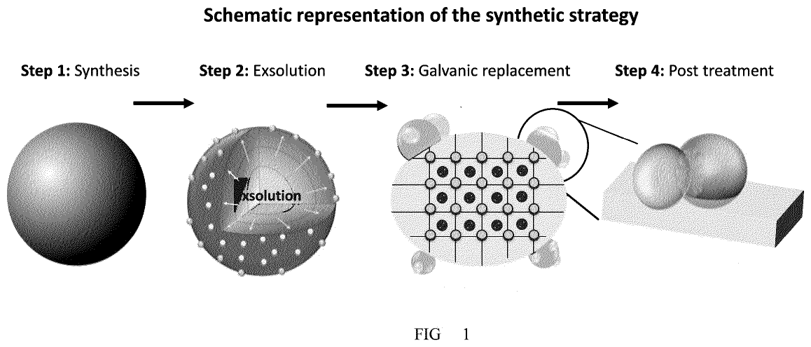

FIG. 1. Schematic representation of the overall synthesis procedure

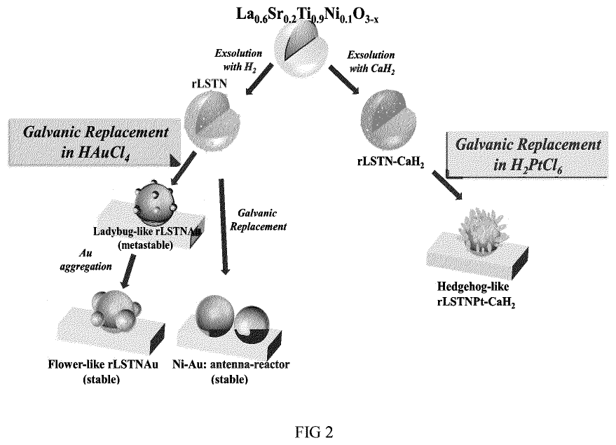

FIG. 2. Schematic representation of the synthesis steps for plasmonically active (left hand side—example of Au (antenna) Ni (reactor) configuration on the surface of La-doped SrTiO₃ (STO)—the material is defined as STO-NiAu and electrocatalytically active (right hand side—example of NiPt bimetallic nanoparticles, embedded on the surface of STO (STO-NiPt) for the hydrogen evolution reaction (HER) during alkaline water electrolysis) nanoparticles on the surface of the host perovskite.

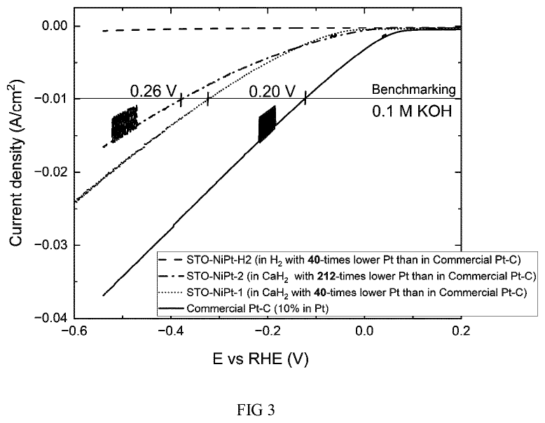

FIG. 3. Electrocatalytic performance for the HER in alkaline conditions (0.1 M KOH) of commercially available catalyst (Pt-C-5 nm Pt nanoparticles on carbon black, 10% Pt content) and catalysts prepared by our invention (STO-NiPt-1=40 times lower Pt than Pt-C; STO-NiPt-2=212 times lower Pt that Pt-C). It is noted that the said catalysts contain two and three orders of magnitude lower mass of Pt. It is also noted that for this application the host perovskite (STO substrate) must be treated in the presence of CaH₂, which creates a more reducing atmosphere than H₂ gas. This is given/exemplified in sample named as STO-NiPt-H₂, which has very low HER activity.

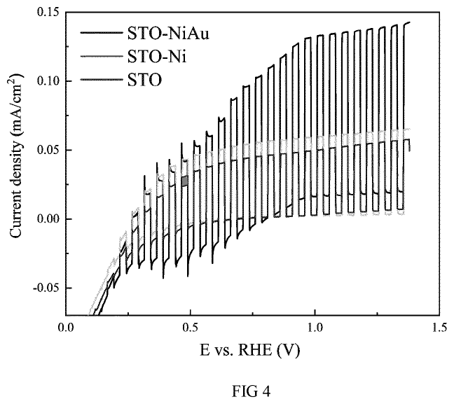

FIG. 4. Photoelectrocatalytic activity of photoactive catalysts containing only the substrate (STO), exsolved Ni nanoparticles from STO (STO-Ni) and galvanically replaced Ni by Au nanoparticles, embedded on the surface of STO (STO-NiAu). STO-NiAu is plasmonically active (antenna-reactor).

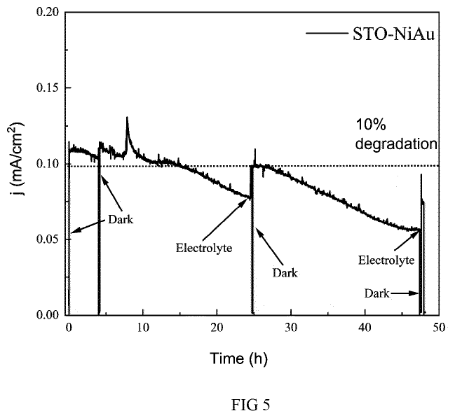

FIG. 5. Long term stability of the plasmonically active photocatalyst, STO-NiAu in strong alkaline conditions (1 M KOH). Where “Electrolyte” it means that the system is supplied with water in order to compensate the evaporation during long term operation under 1 sun simulated conditions. After 48 h of continuous operation in strongly alkaline conditions, the degradation was approx. 33%. This degradation rate is among the lowest reported for such long-running operating times in strongly alkaline conditions.

### EXAMPLES

### Example 1—Powder Synthesis: Nanoparticles on Particles

Appropriate precursor powders were utilised, i.e., lanthanum oxide (La₂O₃, Sigma Aldrich, CAS: 1312-81-8), strontium carbonate (SrCO3, 99%+1% Ba, Johnson Matthey GmbH, CAS: 1633 May 2), titanium dioxide (TiO₂, anatase, Sigma Aldrich, CAS: 1317-70-0), and nickel nitrate hexahydrate (99.999%, Sigma Aldrich, CAS: 13478-00-7) for Ni-doped LSTO. Powders were mixed with acetone and ultrasonicated. Subsequently, the acetone was evaporated, and pressed into a pellet. The pellet was calcined at 1000° C. for 12 h, and afterwards crushed and ball milled at 250 rpm for 2 h in isopropanol. The isopropanol was evaporated before the powder was pressed into a pellet and sintered at 1100° C. for 12 h, before the crushing and ball-milling was repeated and the dried powder was calcined for a third time at 1200° C. The subsequent exsolution occurred either in a ProboStat™ cell (NorECs AS, Norway) under continuous H₂ flow or in combination with CaH₂. The temperature and time varied for exsolution in H₂ for getting the exsolved nanoparticles with varied size and distribution density. The CaH₂ and sample were mixed and pressed into a lose pellet (minimal pressure in the cold press (Atlas Manual Hydraulic Press 15T, Specac)) before being sealed inside an ampule. Exsolution was achieved by keeping the ampule at 580° C. to 600° C. for 72 h. The CaO and remaining CaH₂ was removed by washing the powder in a methanolic solution containing 0.1 M NH₄Cl. Galvanic replacement occurred in a solution of 1×10⁻³ M HCl, 1×10³ M HAuCl₄ and 1×10⁻³ M polyvinylpyrrolidone (PVP) at 60 to 90° C. for the preparation of NiAu bimetallic containing catalysts. For the synthesis of NiPt-bimetallic-containing catalysts, galvanic replacement typically occurred in a solution with 1×10⁻³ M of an appropriate metal complex (H₂PtCl₄), and 0.1 M perchloric acid (HClO₄), typically at 80° C. (see FIG. 2).

### Example 2: Thin Film Synthesis

### 2.1 Preparation of Pellets

The pellet serving as target in the pulsed laser deposition (PLD) determines the stoichiometry of the thin film. Thus, local variations in stoichiometry within the pellet can have a significant influence on the stoichiometry of the thin film, while the density and diameter determine how many depositions can be run with the same pellet. Creating a pellet starts by weighing the correct amount of precursor powders. For A-site excess Ni-doped pellets typically strontium carbonate (SrCO3, 99%+1% Ba, Johnson Matthey GmbH, CAS 1633 May 2), titanium dioxide (TiO₂, anatase, Sigma Aldrich, CAS: 1317-70-0), and nickel nitrate hexahydrate (99.999%, Sigma Aldrich, CAS: 13478-00-7) were used. The powders were mixed and ball-milled in an agate jar with agate balls for 3 h at 300 rpm. The ball milled samples were dried in a heating cabinet at 120° C., before being calcined at 450° C. for 4 h. The resulting powder was mixed with binder (B60/B709, mixed with ethyl acetate type, 17 drops per gram of powder) by mortar and pestle, and a dye of 20 mm was used to press the powder into a pellet. 13.26 Nm⁻² of pressure were applied by a (Atlas Manual Hydraulic Press 15T, Specac) cold press. The green body was placed on sacrificial powder inside an alumina crucible, and covered with sacrificial powder. Subsequently, the pellet was sintered at 1100° C. for 12 h. The resulting pellets had a uniform color indicating a uniform stoichiometry across the entire pellets.

### 2.2 Thin Film Deposition

The targets utilised were made based on the desired stoichiometry of the thin film. The substrates to deposit the films on were, unless otherwise indicated, Si (001) wafers (Si, N<100>, 2″, Si-mat). The strength of the laser and position of the focusing lens were set such that the plasma plume grazed the substrate. The particular machine (Surface-Tec system, laser: Coherent COMPex Pro 205F, KrF, wavelength: 248 nm) utilised during this work allowed up to four targets simultaneously in the deposition chamber. Moreover, four substrate position can be chosen. However, when depositing multiple samples simultaneously, cross-deposition will occur. The distance between substrate and target was kept to 9 cm. The substrate temperature was set to be at 600° C., a temperature stable during deposition, and generally allowing for crystalline growth, but not always. A film thickness of 500-1000 nm was achieved by depositing a total of 20′000 laser pulses, with a repetition rate of 5 to 10 Hz. The targets were rotated with 5 rpm during the deposition. Individual targets were used for multiple depositions, where the surface prior to every deposition was flattened by mechanically grinding the target until the surface was flat.

### 2.3 Post-Deposition Annealing and Exsolution

Some thin films were post-annealed after deposition. The annealing typically occurred prior to exsolution and was conducted at 900° C. in ambient pressure and atmosphere. The purpose of post-deposition annealing was to homogenize the thin films before exsolution. Exsolution of thin films was conducted in the ProboStat™ (NorECs AS, Norway) at 800° C. The reducing atmosphere was either a continuous flow of HArmix (5% H₂ and 95% Ar) or pure H₂. For safety reasons, the system was flushed by Ar for 15 minutes prior to starting exsolution, and similarly for 15 minutes after the furnace reached room temperature, again. Additionally, multiple exsolution times, referring to the time the sample was kept at 800° C. were studied. The heating and cooling rates were 5° C. min⁻¹. However, the furnace was unable to follow the cooling rate below temperatures of ˜250° C. Subsequently, the freshly exsolved thin films were used in GRR as quickly as possible, or stored in ambient conditions.

### 2.4 Galvanic Replacement

The GRR of nanoparticles in thin films was conducted in a double jacketed glass connected to a thermostated water bath. The temperature set was at 80° C. with the replacement solution reaching a temperature of 77° C. The appropriate replacement solution contained Pt, Ag, or Au based on the desired experiment. Replacement time ranging from 5 s to 90 s were used. After GRR the samples were rinsed with de-ionized H₂O, dried in air, and stored in ambient conditions for analysis.

### Example 3: Electrocatalytic Testing

The electrochemical measurements in FIG. 3 were carried out with a rotating disc electrode (RDE) with glassy carbon (GC) as the tip (RDE710 Rotating Electrode from Gamry Instruments) as the working electrode, a standard Hg/HgO as the reference and a graphite rod as the counter electrodes. The supporting electrolyte was 0.1 M aqueous KOH solution. The RDE was coated with the as-prepared catalyst ink which were drop-cast on the GC tip (0.196 cm²) by applying 4 μL of ink and then dried for 10 min at 60° C. This procedure resulted in the loading of ˜0.5 mg of the electrocatalyst on the GC. Linear sweep voltammograms (LSV) were recorded at a scanning rate of 10 mV/s (steady-state conditions) with potential scanning direction from more positive to more negative potentials against the reversible hydrogen electrode (RHE). The presented curves are the stabilised ones after at least five consecutive LSV measurements.

### Example 4: Photoelectrochemical (PEC) Activity

PEC measurements in FIG. 4 were performed on a standard three-electrode set up with NaOH (1 M, pH 13.6) as the electrolyte, Hg/HgO and a platinum foil as the reference electrode and counter electrode, respectively. The working electrodes containing the investigated catalysts were prepared as follows: adding 100 mg of powder in a mixture of 2.5 mL water, 1.25 mL isopropanol, and 30 μL of 5 wt. % Nafion, followed by the sonication for 3 h to obtain a homogeneous ink.

Applying 50 μL of ink on the Ti foil (1 cm²) by the drop-cast method and then anneal at 600° C. under an inert atmosphere for 0.5 h to achieve the stable reconstructed nanostructure, in addition to a better adhesion with the Ti foil substrate. All the tests were conducted by a Gamry Reference 3000 potentiostat, under 1 sun simulated solar light from a Newport Oriel LCS-100 solar simulator equipped with a 100 W ozone-free xenon lamp and an AM 1.5G filter. The light intensity was regularly calibrated by a monocrystalline Si PV reference cell (Newport 91150V-KG5). All over potentials are corrected against the RHE taking into account that water electrolysis takes place thermodynamically at 1.23 V versus RHE.

The LSV curve was recorded upon switching the light on and off with a shutter, with the recorded signal reflecting the transport and recombination behaviours of photo-generated charge carriers. All LSV curves were recorded at a scanning rate of 10 mV/s (steady-state conditions) with potential scanning direction from less positive to more positive potentials against the RHE.

### Example 5: Long Term Stability

For long-term electrocatalytic stability experiments, as shown in FIG. 5, the same electrode (STO-NiAu) as in Example 4 above was evaluated by galvanostatic measurements at a fixed potential of 1.23 V vs RHE for 48 hours in strong alkaline conditions (1 M KOH). Periods of light OFF conditions are indicated, as well as periods when the solution was refilled with water to account for electrolyte evaporation.

1. A solid catalyst comprising a bulk material containing metal nanoparticles, wherein a portion of said nanoparticles partially protrude from the surface of the bulk material and said nanoparticles are characterised in that they comprise a noble metal or non-noble metal on their surface.

2. The catalyst as claimed in claim 1, wherein the bulk material is a metal oxide.

3. The catalyst as claimed in claim 2, wherein the oxide is a perovskite.

4. The catalyst as claimed in claim 2, wherein said metal oxide is a binary oxide.

5. The catalyst as claimed in claim 18, wherein A is selected from the group consisting of Li, K, Ca, Sr and B is selected from the group consisting of Ti, Nb, Zr and Sn.

6. The catalyst as claimed in claim 5, wherein the bulk material is BaTiO₃, SrTiO₃, LiNbO₃ or BaZrO₃.

7. The catalyst as claimed in claim 1, wherein said metal nanoparticles comprise a transition metal.

8. The catalyst as claimed in claim 1, wherein said noble metal is ruthenium (Ru), rhodium (Rh), palladium (Pd), osmium (Os), iridium (Ir), platinum (Pt), gold (Au) or silver (Ag).

9. The catalyst as claimed in claim 1, wherein said non-noble metal is copper (Cu), molybdenum (Mo), tellurium (Te) or tin (Sn).

10. The catalyst as claimed in claim 1, wherein said non-noble metal is a non-noble transition metal.

11. The catalyst as claimed in claim 1, wherein said catalyst is in the form of a powder or a film.

12. A process for preparing the solid catalyst as defined in claim 1, said process comprising the steps:
(i) providing a bulk material comprising at least one metal dopant;
(ii) subjecting said bulk material to reducing conditions so as to allow exsolution of nanoparticles of the metal dopant; and
(iii) contacting the bulk material obtained in step (ii) with a solution comprising noble metal ions or non-noble ions so as to allow galvanic replacement and/or deposition of said noble metal ions or non-noble metal ions on said nanoparticles as metallic heteroatoms.

13. The process as claimed in claim 12, wherein step (ii) takes place in an H₂, CO, CO₂ or NH₃ atmospheres.

14. The process as claimed in claim 12, wherein step (ii) is performed in the presence of CaH₂.

15. The process as claimed in claim 12, wherein the exsolution step (ii) takes place at a temperature in the range 500 to 1100° C.

16. The process as claimed in claim 12, wherein the solution in step (iii) is an aqueous solution.

17. The process as claimed in claim 12, wherein step (iii) takes place at a temperature of 1 to 90° C.

18. The catalyst as claimed in claim 3, wherein the perovskite is represented by the general formula: 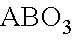
wherein
A is an alkali metal, alkaline earth metal, transition metal or mixture thereof, and
B is a transition metal, group III metal, group IV metal, or a mixture thereof.

19. The catalyst as claimed in claim 4, wherein the binary metal oxide is aluminum oxide (Al₂O₃), silicon dioxide (SiO₂), cerium dioxide (CeO₂), or titanium dioxide (TiO₂).

20. The catalyst as claimed in claim 7, wherein the transition metal is selected from the group consisting of nickel (Ni), iron (Fe), cobalt (Co), and copper (Cu).
